(19) United States
(12) Patent Application Publication
(10) Pub. No.: US 2024/0330355 A1
(43) Pub. Date: Oct. 3, 2024

(54) METHODS AND SYSTEMS GENERATING CURATED PLAYLISTS

(71) Applicant: Rovi Guides, Inc., San Jose, CA (US)

(72) Inventors: Nathan Peirce, Sharon Hill, PA (US); Eric Michael Wagner, Drexel Hill, PA (US); Christopher Lawrence Dick, Philadelphia, PA (US); Alok Kothana, Malvern, PA (US); Brandon D. Conley, Wynnewood, PA (US)

(21) Appl. No.: 18/743,406

(22) Filed: Jun. 14, 2024

Related U.S. Application Data
(63) Continuation of application No. 16/208,093, filed on Dec. 3, 2018.

(51) Int. Cl. G06F 16/438; G06F 16/435; G06F 16/48; H04L 67/50

(52) U.S. Cl. CPC G06F 16/4387; G06F 16/437; G06F 16/489; H04L 67/535

(57) ABSTRACT

Methods and systems are described herein for an application that generates curated playlists based on the needs of a user. In addition to relieving the user of determining search terms, the application provides a smarter search methodology by first breaking the needs of the user into one or more tasks and searching for media content related to those tasks that are in a style suitable for the user. The application then automatically organizes, based on profile information about the user, the media content in the playlist according to the needs of the user.

### CROSS-REFERENCE TO RELATED APPLICATION

This application is a continuation of U.S. patent application Ser. No. 16/208,093, filed Dec. 3, 2018, the disclosure of which is hereby incorporated by reference herein in its entirety.

### BACKGROUND

Today users have access to seemingly endless amounts of media content related to subject matter of every type. Users may consume this media content for entertainment or for educational purposes. However, whether selecting media content for entertainment or educational purposes, users must first wade through this vast amount of content to find something that is enjoyable and/or useful. This problem is particularly vexing when a user is searching for particular media content or media content about a particular subject or for a particular purpose. The problem only increases if the user is unable to clearly describe the media content that is needed.

### SUMMARY

In view of this problem, methods and systems are described herein for an application that generates curated playlists based on the needs of a user. Furthermore, to solve the aforementioned problems implicit in searching for media content, the application automatically determines those needs. For example, as opposed to conventional searching tools, the application does not rely on a user to determine the search terms. Instead, the application automatically determines what media content is needed and generates a curated playlist with that content. In addition to relieving the user of determining search terms, the application provides a smarter search methodology by first breaking the need of the user into one or more tasks and searching for media content related to those tasks that are in a style suitable for the user.

Moreover, as opposed to conventional searching tools that would require a user to sift through search results, the application automatically organizes the media content in the playlist according to the needs of the user. Specifically, the application organizes the media content based on the proficiency level of the user and the urgency level in completing a task by a specific date. Thus, the user is relieved of having to determine how to search for media content as well as having to organize media content appearing in search results. In fact, not only is the user relieved of these burdens, but also the application provides better search results as the searches are based on individual tasks, and the playlist of search results features enhanced curation as the playlist is ordered based on the proficiency and urgency of the user-advantages that could not be realized in conventional systems.

In one aspect, the application generates curated playlists for accomplishing given tasks based on characteristics of users. To do this, the application determines an event in which a user will participate on a date. For example, the application may receive a user input of an event (e.g., a tennis tournament) in which the user will be participating at some future date (e.g., one month from now). Alternatively or additionally, the application may automatically determine the event and the date of the event by using data from another application (e.g., a calendar application for the user that lists the tennis tournament). By determining the event and the date of the event, the application can determine the one or more tasks to break the event into in order to provide the enhanced search capability discussed above.

The application then determines a task required of the user to participate in the event. For example, the application may compare the event (e.g., tennis tournament) to listings in a database of tasks related to events to determine one or more tasks (e.g., playing tennis, proper swing techniques, tennis rules, etc.) required of the user to participate in the event. By determining a task required of the user to participate in the event, the application can search for the individual tasks related to the event in order to provide more targeted results, targeted results that improve the ability of the application to curate the playlist as discussed below. For example, the curated playlist may tailor content to the proficiency level of a user (as discussed below). However, if the application attempts to tailor content to broadly defined events, the application the media content selected may not precisely meet the needs of the user. This problem is further increased as determining criteria for the playlist such as proficiency level, content format preferences, urgency level, etc., for broad, ambiguously defined events is more difficult. To prevent this problem, the application first determines the individual tasks that correspond to an event.

The application then determines, based on a user profile, a proficiency level of the user in performing each task. For example, the application may compare the task to listings in a database of indicia of proficiency levels of users in performing respective tasks to determine an indicium of the proficiency level of the user in performing the task, determine a value of the indicium in the user profile, and use the indicium to determine the proficiency level of the user in performing the task. For example, to determine the proficiency level of a user in playing tennis, the application may receive indicia such as the user's tennis league statistics, the user's swing speed (e.g., from a wearable electronic device), the user's age, etc.). By customizing the indicia used to determine the proficiency level based on the tasks to be completed (as opposed to using generic indicia for all tasks), the application can retrieve information that provides a better indication of the proficiency level of the user. Additionally, the application may be able to select from one or more types of data that correspond to different indicia. These types of data could be further rated based on the task, availability of the data, or amount of the data.

The application may then determine a content format suitable for the user based a knowledge level, proficiency level, or age of the user. For example, the application may compare the knowledge level, the proficiency level, or the age of the user to listings in a database of content formats (e.g., content formats that are age-, proficiency-level, or knowledge-level appropriate) for respective knowledge levels, proficiency levels, or ages of users to determine the content format suitable for the user. By determining a training level suitable for the user, the application can better select media content that is likely to provide the best results in improving the proficiency level of the user. Likewise, the application may additionally or alternatively determine an individual training level suitable to the user based on information in a user profile (e.g., types of content formats that are frequently used by the user, content formats that achieve the best results for the user, etc.).

The application may then determine an urgency level to increase the proficiency level of the user prior to the date. For example, the application may keep track of the passage of time relative to the date of the event. As the current date becomes closer in time to the date of the event, the application may increase the urgency of the event. In another example, the application may monitor a social media account of the user for electronic communications (e.g., posts, messages, etc.) related to the event, calculate a number of the electronic communications related to the event, and use the number of the electronic communications related to the event to determine the urgency level, as the presence of more frequent communications about the event may indicate an increased urgency. Alternatively or additionally, the application may monitor a location (e.g., a room featuring smart home equipment) for communications (e.g., the user discussing the event) related to the event, calculate a number of the communications related to the event at the location, and use the number of the communications related to the event to determine the urgency level, as frequent comments by the user about the event may indicate an increased urgency. Alternatively or additionally, the application may monitor a plurality of locations for user communications related to the event, calculate a number of locations of the plurality of locations at which the user's communications related to the event were detected, and use the number of the locations to determine the urgency level, as the number of different places at which the user discussed the event may indicate an urgency.

The application may then generate a curated playlist of media assets for increasing the proficiency level of the user prior to the date, wherein the media assets are selected for the curated playlist based on the proficiency level, content format preferences, and urgency level. For example, the application may filter available media assets related to the task based on the content formats to determine a first subset of media assets, determine proficiency levels associated with each of the first subset of media assets, filter the first subset of media assets based on the proficiency level associated with each media asset to determine a second subset of media assets, wherein each of the media assets in the second subset of media assets has a respective proficiency level equal to or above the proficiency level of the user, order each of the media assets in the second subset of media assets based on its respective proficiency level, and select, based on the urgency level, a number of the ordered media assets from the second subset of media assets to be used to generate the curated playlist. By generating the playlist based on the proficiency level, content format preferences, and urgency level, the application provides an improved playlist for increasing the proficiency of the user beyond that available through conventual systems.

It should be noted that the methods and systems described herein for one embodiment may be combined with other embodiments as discussed herein.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a system that detects that a user needs to learn something, determines learning parameters, and curates a content bundle based on the learning parameters, in accordance with some embodiments of the disclosure;

FIG. 2 shows another illustrative example of a system in which a user inputs information relating to something the user needs to learn, the system determines learning parameters, and the user receives a curated content bundle based on the learning parameters, in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a diagram of information flow into a curation engine to create a curated content bundle.

FIG. 6 is an illustrative formulaic engine for determining a content bundle based on experience level, urgency level, knowledge level, event type, preferred content format, optimal content format, and level.

FIG. 7 depicts an illustrative flowchart of a process for generating a curated playlist of media assets for increasing a proficiency level of a user prior to a date of an event, in accordance with some embodiments of the disclosure;

FIG. 8 depicts an illustrative flowchart for determining a score for a retrieved value of an indicium, in accordance with some embodiments of the disclosure;

FIG. 9 depicts another illustrative flowchart for assigning an urgency level to an event, in accordance with some embodiments of the disclosure; and

FIG. 10 depicts another illustrative flowchart for selecting the starting point that corresponds to a received urgency level.

### DETAILED DESCRIPTION

Methods and systems are described herein for an application that generates curated playlists based on the needs of a user. As opposed to conventional searching tools, the application does not rely on a user to determine the search terms. Instead, the application automatically determines what media content is needed and generates a curated playlist with that content. In addition to relieving the user of determining search terms, the application provides a smarter search methodology by first breaking the needs of the user into one or more tasks and searching for media content related to those tasks that are in a style suitable for the user. The application then automatically organizes, based on profile information about the user, the media content in the playlist according to the needs of the user as opposed to conventional searching tools that would require a user to sift through search results. For example, the application organizes the media content based on the proficiency level of the user and the urgency level in completing the task by a specific date. Thus, the user is relieved of having to determine how to search for media content as well as having to organize media content appearing in search results. In fact, not only is the user relieved of these burdens, but also the application provides better search results as the searches are based on individual tasks and the playlist of search results features enhanced curation as the playlist is ordered based on the proficiency and urgency of the user-advantages that could not be realized in conventional systems.

In one embodiment, the application generates curated playlists for accomplishing given tasks based on characteristics of users. To do this, the application determines an event in which a user will participate on a date. As referred to herein, the term “event” should be understood to mean something that happens, or an occurrence. The event may be an occurrence in the user's future for which the user must prepare. In some embodiments, the event may be a live event. An example of a live event may be an orchestra concert in which musicians perform music for an audience. This event would be considered live because the user (e.g., in the audience) observes the musicians' performance as they play the music. In another example, a math test would be a live event, as a student's math knowledge is being tested through the act of completing the math test.

In some embodiments, the event may be a recorded event. For example, a sitcom episode may be a recorded event because it is observed by viewers on their televisions at a point in time later than when it was recorded. In other words, the actors' performances are not observed by television viewers until after the entire episode is completed and broadcast to viewers. Another example of a recorded event may be a recipe for how to cook a dish, such as a casserole. The recipe was recorded at a certain point in time, and a user may decide to make the casserole at a later point in time. The quality of the recipe and casserole are evaluated after the user finishes cooking the recipe.

In some embodiments, the event may be an electronic event. For example, an electronic event may be a photograph uploaded to a user's social media account. The content of the photograph is communicated electronically to any viewers who have access to view the user's social media content. In addition, electronic events may be classified as either live events or recorded events, as described above. An example of a live electronic event may be an episode of a live show on television, such as an episode of the dance competition show “So You Think You Can Dance,” because this event is transmitted over a communications network to viewers and because it may be viewed as it is occurring. An example of a recorded electronic event may be a lecture video that is uploaded online to teach students how to speak Spanish. In this example, the lecture video is transmitted to students over a communications network and is evaluated at a point in time later than when it occurs.

In some embodiments, the event may be an in-person event. An example of an in-person event may be changing a flat tire on a user's car. This is an example of an in-person event because the user must be present for the event at the particular location of the car and at the particular time the car receives a flat tire. Furthermore, the process of the user changing the tire and the success of the user in changing the tire are observed and evaluated as the event is occurring. For this reason, the event in this example may be additionally classified as a live, in-person event.

In addition to an event, the application may determine a date on which the event will occur. For example, a date may mean a certain day or days. For example, a date may refer to “Oct. 20, 2018.” In another example, a date may refer to “tomorrow.” In another example, a date may mean “this Saturday” or “in a week.” In another example, a date may refer to “the first weekend in September.”

In some embodiments, a date may refer to a time of day. For example, a date may refer to “morning,” “noon,” “4 pm,” “21:00,” “after 10:30 am,” and/or any other time of day. In some embodiments, a date may refer to a time in relation to an event. For example, a date may mean “before dinner,” “during class,” “after work,” and/or any other point in time that is relation to an event. In some embodiments, a date may comprise a combination of a day and a time. For example, a date may refer to “1:30 pm on Tuesday” or “10 am on Dec. 18, 2019.” Such a specific time may assist a participant in an event to coordinate with other participants and/or with viewers.

In some embodiments, a date may reference a specific event in a user's life. The details of this event may vary from person to person. For example, the date “my birthday” may refer to July 23^{rd} for a first user and may refer to April 16^{th} for a second user. In other situations, a date may be based on something significant to a plurality of people. For example, a date may refer to a holiday celebrated by people of a particular religion, such as Rosh Hashanah or Christmas. In another example, a date may refer to an event, which happened in the past between a plurality of people, that is celebrated annually. An example of such a date may be a wedding anniversary celebrated by two people who were married a number of years before. In some embodiments, a date may refer to an event that has yet to be determined, such as “after I finish writing my thesis.” As illustrated by these examples, dates that are based on details of a particular person's life may be established, undetermined, fixed, and/or undecided.

In some embodiments, a date may be understood to mean a range of times or days. For example, a date may refer to a range of times on a particular day, such as “between 2 pm and 4 pm tomorrow.” In another example, a date may refer to a range of days, such as “sometime next month.” A date that refers to a range of times may give a user flexibility in determining how to prepare for an event, as they may be able to manipulate the specific date on which the event occurs if more preparation time is needed.

In some embodiments, the application may receive a user input of an event (e.g., a tennis tournament) in which the user will be participating at some future date (e.g., one month from now). The user may have options for how the event and time are inputted, in terms of specificity and/or flexibility.

Alternatively or additionally, the application may automatically determine the event and the date of the event by using data from another application. In one example, data may be pulled from a user's social network account, in which the user has added an event to the application's calendar feature. For instance, the user may have indicated that they are interested in or going to a poetry slam competition that will take place the following Friday at 8 pm. The application may then determine that the event is a poetry slam competition and that the date is next Friday at 8 pm. In another example, the application may pull data from a messaging platform on the user's smartphone. For instance, the user may have agreed to run a half marathon with a friend in an exchange that took place over text. By parsing and analyzing the strings of text in the exchange, the application may determine that the user will run the half marathon on Nov. 11, 2018 at 10 am. By determining the event and the date of the event, the application can determine the one or more steps to break the event into in order to provide the enhanced search capability discussed above.

The application then determines a task required of the user to participate in the event. A task may include one or more steps a user must take in order to prepare for a future event. Tasks may take on a variety of forms, as well as a combination of forms.

In some embodiments, a task may be an acquisition of knowledge. The complete acquisition of knowledge relating to a topic may correspond to an event itself, such as learning to write a code in Python. The tasks may correspond to the individual steps that teach a user how to code in Python. For example, the user may first need to learn terminology for pieces of Python code. Later, the user may learn how to combine pieces of code into working functions. Finally, the user may compile all the knowledge they have learned into an ability to write working Python code. In another example, the event may require a level of background knowledge. A political event-such as a speech, debate, or rally—may require that a user knows about the candidates and their platforms in order to observe and/or participate in the event. Tasks corresponding to this event may include videos about political parties, platforms, and specific candidates. The user may then use this acquired knowledge at the political event.

In some embodiments, a task may be a repetitive act that the user completes many times in order to practice for an event. For example, in order to prepare for an audition, an actress may practice her lines in a script many times in order to memorize and perfect the content. In this instance, the actress completes the same task many times in a row in order to prepare for the event in which she will present her work.

In some embodiments, a task may be the act of acquiring something that the user needs for an event. For example, if the event is that a user wishes to plant a flower garden in the spring, the user may need to gather a variety of tools in order to prepare for the event. The user may need to acquire mulch, a shovel, seeds, a watering can, and a variety of other items needed for gardening. In this example, each task may correspond to a particular item that the user will need in order to start gardening.

In some embodiments, a task may be a skill that requires a user to develop some sort of talent. For example, the event may be a yoga class that a user will teach in the future. This event requires that the user develop a certain number of skills, such as balance and flexibility. Tasks for these skills may include stretching a different group of muscles every day or spending a certain amount of time each day balancing in different positions. In this example, the event of teaching a yoga class requires a plurality of types of tasks. The user must acquire the necessary tools (e.g., yoga mat and yoga apparel), learn the vocabulary to describe various yoga positions and moves, and practice each position and move repetitively in order to improve their abilities. It should be noted that any of these types of tasks may be combined in order to help a user prepare for an event.

In order to determine which tasks are needed in order to prepare for a given event, the application may compare the event to listings in a database of events. For example, the event may be “learn to paint.” The application may search the listings of the database for types of events related to painting. The listings may include categories such as “learn watercolor painting,” “learn acrylic painting,” and “learn oil painting.” The listings may further specify subcategories such as styles of painting, which may include “learn abstract painting,” “learn realistic painting,” and “learn impressionistic painting,” among other styles. It should be noted that there may be any number of categories and subcategories in order to determine the details of the event in which the user wishes to participate. The application may require user input in order to narrow down these categories of events, such as requiring a user to answer a number of questions about the type of painting the user wishes to learn to make. Additionally or alternatively, the application may draw data about the specific nature of the event from a secondary application. For example, the application may find relevant details in the user's online search history, such as a number of searches the user performed for images of Claude Monet paintings. From this information the application may determine that the user is interested in learning impressionistic painting. The application may additionally or alternatively search for information regarding an event stored in a third application, such as the user's personal calendar. The application may find data identifying the event as a “photorealism painting competition.” The application may use these techniques, in addition to others, individually or in combination to determine the details of the event.

In some embodiments, the application may compare the given event to listings in a database of tasks related to events to determine one or more tasks required of the user to participate in the event. The application may initially compile a listing of every task related to the specific, given event. For example, if the user wishes to play in a tennis tournament, the application may list the equipment the user must acquire, the terminology and rules the user must learn, the proper swing techniques, the proper way to serve, and the moves that the user should practice prior to the tournament. The application may further analyze each task in the listing to ensure that each task is unique so that the user is not presented with repetitive information. The application may analyze the descriptions of each task to identify keywords, and in the event of finding two tasks with the same descriptive keywords, the application may select one of the tasks to keep while removing the other. In some embodiments, the application may analyze the metadata of each task for data identifying the task. In the event of finding two tasks with the same identifying data, the application may select one of the tasks to keep while removing the other from the list.

By determining a task required of the user to participate in the event, the application can search for the individual tasks related to the event in order to provide more targeted results-targeted results that improve the ability of the application to curate the playlist as discussed below. For example, the curated playlist may tailor content to the proficiency level of a user (as discussed below). However, if the application attempts to tailor content to broadly defined events, the application the media content selects may not precisely meet the needs of the user. This problem is further increased as determining criteria for the playlist such as proficiency level, content format preferences, urgency level, etc., for broad, ambiguously defined events is more difficult. To prevent this problem, the application first determines the individual tasks that correspond to an event.

The application then determines, based on a user profile, a proficiency level of the user in performing each task. The application may determine a broad proficiency level, such as novice, rookie, beginner, talented, skilled, intermediate, seasoned, experienced, advanced, senior, expert, etc. The application may analyze the information in the user profile for physical characteristics and experience of the user. For example, the application may identify that a user plans to participate in an event (e.g., tryouts for the rowing team) that requires certain physical characteristics and some prior training. The application may identify that the user is tall and athletic but has no experience with rowing. This may prompt the application to label the user as a beginner.

In some embodiments, the application may determine proficiency level based on events related to the upcoming event. For example, a user may wish to participate in a kickball tournament in one month. The application may search the user profile for relevant information and find that although the user has never played kickball before, the user played baseball competitively for many years. The application may recognize that many aspects of baseball and kickball are similar (the layout of the field, the basic objective, the timing and running skills required, etc.). This may prompt the application to label the user as talented and may focus on selecting tasks that teach the skills of kickball that differ most from the skills of baseball.

In some embodiments, the application may analyze the information in the user profile to determine how many of the tasks the user has already completed. These tasks may have been completed for a separate event but nonetheless have moved the user closer to their goal of preparing for the given event. For example, a user may wish to learn how to bake a soufflé, which requires certain baking tools and utensils. The initial tasks in the listing of tasks may instruct the user to obtain these necessary tools and utensils. However, the application may determine that the user has already purchased some or all of these tools and utensils for another baking or cooking project. The application may determine this by comparing data identifying products in the user's purchase history to data identifying products required by the tasks. In this example, the application may determine that the user may skip the first five tasks, all of which involve obtaining tools and utensils, which may prompt the application to label the user as intermediate.

In some embodiments, the application may compare the task to listings in a database of indicia of proficiency levels of users in performing respective tasks to determine an indicium of the proficiency level of the user in performing the task, determine a value of and/or the corresponding indicium in the user profile, and use the indicium to determine the proficiency level of the user in performing the task. For example, to determine the proficiency level of a user in playing tennis, the application may receive indicia such as the user's tennis league statistics, the user's swing speed (e.g., from a wearable electronic device), the user's age, etc. By customizing the indicia used to determine the proficiency level based on the tasks to be completed (as opposed to using generic indicia for all tasks), the application can retrieve information that provides a better indication of the proficiency level of the user. Additionally, the application may be able to select from one or more types of data that corresponds to different indicia. These types of data could be further rated based on the task, availability of the data, or amount of the data.

The application may then determine a content format suitable for the user. As referred to herein, the term “content format” should be understood to mean the format for transferring knowledge to a user for a particular skill or type of behavior. The content format may be broken down into categories such as videos, PDFs, slides, websites, books, audio, documents, podcasts, etc.

In some embodiments, the application may use knowledge level, proficiency level, and age to determine which content format is suitable for the user. As referred to herein, “knowledge level” should be understood to mean the highest level of education and/or training the user has received in any relevant field. For example, knowledge level may refer to physical education that the user has undertaken, which may have covered terminology and skills related to an upcoming tennis event. In another example, knowledge level may refer to singing lessons that a user has taken in the past, which would help the user prepare for an upcoming singing event.

Certain types of content formats may not be suitable for users based on the type of event and the user's preferred method of learning. A suitable content format for someone who learns well with visual materials may include videos, slides, and pictures. In contrast, a user may learn best through audio instruction and may thus prefer content formats that include audio, podcasts, audiobooks, etc.

In some embodiments, the application may compare the knowledge level or the proficiency level of the user to listings in a database of content formats (e.g., content formats that are proficiency-level or knowledge-level appropriate) for respective knowledge levels or proficiency levels of users to determine the content format suitable for the user. By determining a training level suitable for the user, the application can better select media content that is likely to provide the best results in improving the proficiency level of the user. Likewise, the application may additionally or alternatively determine an individual content format suitable to the user based on information in a user profile (e.g., types of content formats that are frequently used by the user, content formats that achieved the best results for the user, etc.).

The application may then determine an urgency level to increase the proficiency level of the user prior to the date. In some embodiments, urgency levels may correspond to broad categories that indicate how much preparation for the event is currently required. Such categories may include low priority, moderate, high priority, serious, critical, and a variety of other labels. The application may perform a calculation based on factors specific to the user, event, and date in order to calculate an initial urgency level. Low proficiency levels may correspond to higher urgency levels while high proficiency levels may correspond to lower urgency levels. Additionally or alternatively, large numbers of tasks required to prepare for the event may cause the application to calculate a higher urgency level. Additionally or alternatively, if a long amount of time separates the user in the present and the date of the event, the application may lower the urgency level. As the event draws closer, however, the application may increase the urgency level. Accordingly, the application may fluctuate the urgency level over time based on the progress of the user, the improvements in proficiency level, the date of the event, and other factors.

In some embodiments, the application may use additional measures to adjust the urgency level. The application may monitor a social media account of the user for electronic communications (e.g., posts, messages, etc.) related to the event, calculate a number of the electronic communications related to the event, and use the number of the electronic communications related to the event to determine the urgency level, as the presence of more frequent communications about the event may indicate an increased urgency. Alternatively or additionally, the application may monitor a location (e.g., a room featuring smart home equipment) for communications (e.g., the user discussing the event) related to the event, calculate a number of the communications related to the event at the location, and use the number of the communications related to the event to determine the urgency level, as frequent comments by the user about the event may indicate an increased urgency. Alternatively or additionally, the application may monitor a plurality of locations for user communications related to the event, calculate a number of locations of the plurality of locations at which the user's communications related to the event were detected, and use the number of the locations to determine the urgency level, as the number of different places at which the user discussed the event may indicate the urgency.

The application may then generate a curated playlist of media assets. It should be understood that the playlist may reside in memory (e.g., database), and the media assets selected for the playlist are selected according to specific parameters, each parameter based on information related to the user and/or needs of the user. In the context of this application, the purpose of the curated playlist of media assets is to increase the proficiency level of the user prior to the date of an event. The playlist is “curated” as the media assets are both selected for, and organized in, the playlist based on the proficiency level, content format preferences, and urgency level. The media assets in the curated playlist may be organized according to tasks that depend on other tasks. For example, tasks that require a user to use a particular tool must be ordered after tasks that require the user to obtain the particular tool. Additionally or alternatively, tasks that depend on knowledge or skills gained from other tasks must be ordered after those other tasks.

Additionally or alternatively, the application may filter the curated playlist by creating two subsets of media assets. For example, the application may filter available media assets related to the task based on the content format preferences to determine a first subset of media assets, determine proficiency levels associated with each of the first subset of media assets, filter the first subset of media assets based on the proficiency level associated with each media asset to determine a second subset of media assets, wherein each of the media assets in the second subset of media assets has a respective proficiency level equal to or above the proficiency level of the user, order each of the media assets in the second subset of media assets based on its respective proficiency level, and select, based on the urgency level, a number of the ordered media assets from the second subset of media assets to be used to generate the curated playlist. By generating the playlist based on the proficiency level, content format preferences, and urgency level, the application provides an improved playlist for increasing the proficiency of the user beyond that available through conventional systems.

In one example, the user may receive an invitation to attend a concert of a band with some new friends in two weeks. The event type may be classified as “music” or “concert.” The deadline of two weeks indicates that the user has some time, though limited, to prepare for the event, thus leading to a medium urgency level. The user may have little or no history listening to the band's music or watching music videos associated with the band. Further, the user has no history of concert ticket purchases or music purchases associated with the band. Therefore, the knowledge and experience levels of the user are very low. The user may wish to prepare for the upcoming concert by learning the music they will hear at the concert. In this instance, the user may need to learn about the artists, listen to the artists' music, and listen to related music. The preferred content format for the user may be music that the user can listen to over the next two weeks. The curated content bundle in this example may be in the form of a playlist of songs and music videos of the band's music and related music, as well as articles about the band's history. The curated content bundle may teach the user about the genre, style, and history of the band as well as song lyrics of the music.

In another example, an event may be a meeting with a company next week, between the user and two employees. The user may be pitching an idea for a television show that the user hopes the company will find interesting. The event type may therefore be “pitch meeting.” The deadline of next week indicates that the user must prepare for the event quickly and efficiently, leading to a high urgency level. In this example, the user's preferred content format may be the company website, which the user can review for background information. The curated content bundle in this example may include the company website and related websites, LinkedIn profiles for the two employees included in the meeting, PDF articles about the company, websites for previous television shows produced by the company, contact information for the employees, and other relevant materials. The curated content bundle may also include materials about successful television show pitches and instructional materials on how to write a pilot for a television show. The curated content bundle may limit the bundle to only the most important materials for the user, due to the urgent nature of the event.

The amount of content available to users in any given content delivery system can be substantial. Specifically, the amount of content available to teach users how to prepare for various activities can be vast and difficult to navigate. Consequently, many users desire a form of media guidance through an interface that allows users to efficiently navigate content selections and easily identify content that they may desire. An application that provides such guidance is referred to herein as an interactive application or, sometimes, an application or a guidance application. Such an application may be useful for users who wish to utilize media content to prepare for an event.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other television equipment, computing equipment, or wireless device, and/or combination of the same. In some embodiments, the user equipment device may have a front-facing screen and a rear-facing screen, multiple front screens, or multiple angled screens. In some embodiments, the user equipment device may have a front-facing camera and/or a rear-facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The applications may be provided as online applications (i.e., provided on a website), or as stand-alone applications or clients on user equipment devices. Various devices and platforms that may implement applications are described in more detail below.

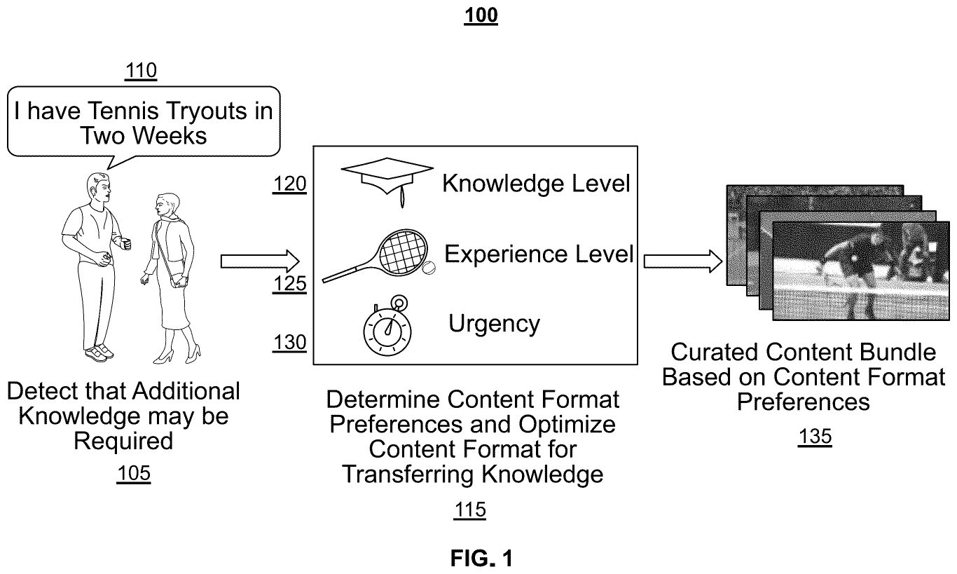

FIG. 1 depicts an illustrative example of how the application operates. The application detects that additional knowledge may be required in step 105 of FIG. 1. For example, the application may hear a conversation between the user and a friend, in which the user makes statement 110. Based on this statement, the application may identify the event as “tennis tryouts” and the date as “in two weeks.” The application may then analyze the user profile to determine content format preferences and optimize content format for transferring knowledge 115, which includes determining characteristics of the user and/or the event that affect how the user will prepare for the event. These parameters may include knowledge level 120, experience level 125, and urgency 130. Based on the event and date from 110 and the optimized content format of 115, the application may create a curated content bundle based on content format preferences 135, which will instruct the user in how to increase their proficiency level prior to the date of the event.

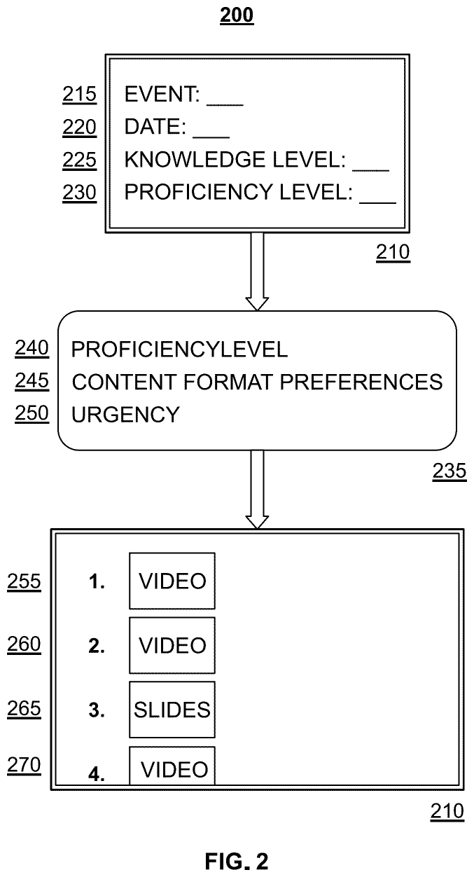

FIG. 2 depicts an illustrative example of a system in which a user inputs information relating to something the user needs to learn. The user may enter information relevant to the event 215 into the user's media display 210. This event may include date 220, knowledge level of the user 225, and proficiency level of the user 230. The application may then use the information entered by the user to determine parameters 235. Parameters 235 may include proficiency level 240, content format preferences of the user 245, and an urgency 250. The application may then display the curated playlist on media display 210 for the user to view. For example, event 215 may be an upcoming tennis match. The curated playlist may then comprise a series of videos and slides that are aimed at preparing the user for the event 215.

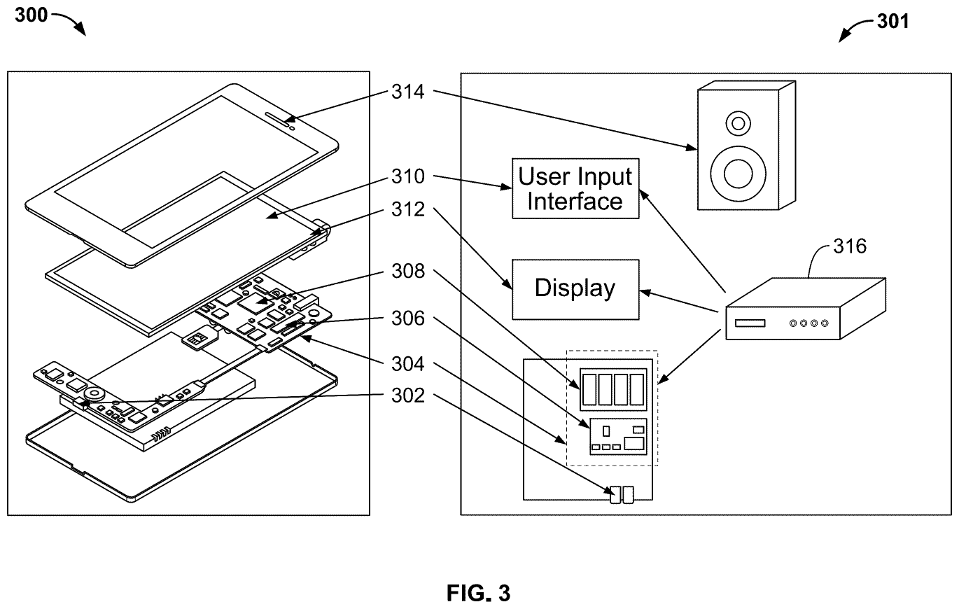

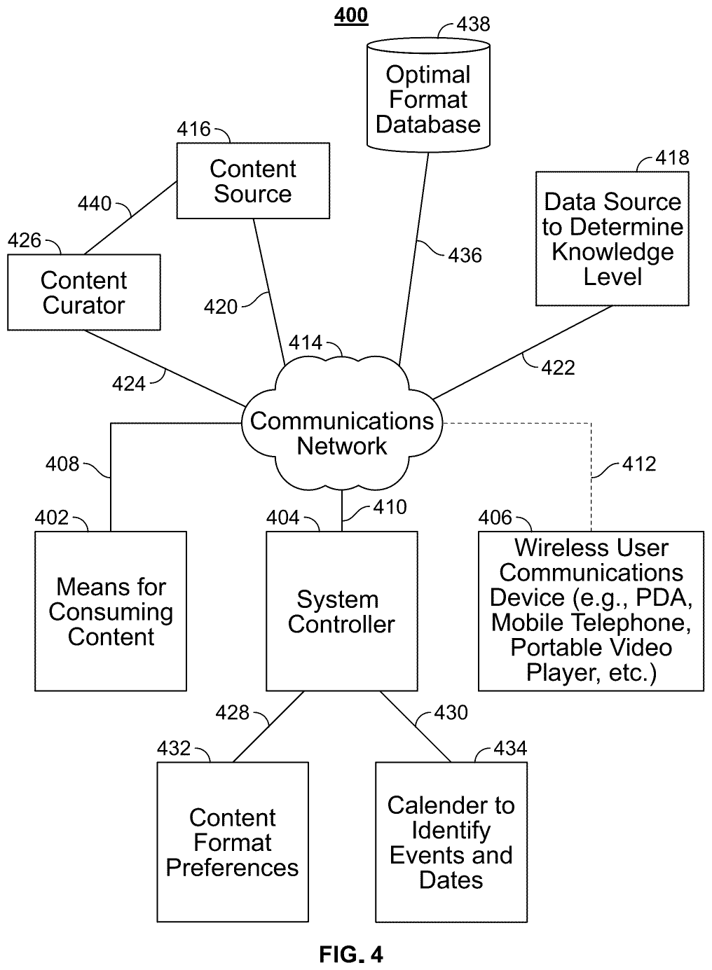

Users may access content and the media guidance application from one or more of their user equipment devices. FIG. 3 shows generalized embodiments of illustrative user equipment device 300. For example, user equipment device 300 may be a smartphone device or a remote control. In another example, user equipment system 210 may be a user television equipment system. User television equipment system 210 may include a set-top box 316. Set-top box 316 may be communicatively connected to speaker 314 and display 312. In some embodiments, display 312 may be a television display or a computer display. In some embodiments, set top box 316 may be communicatively connected to user interface input 310. In some embodiments, user interface input 310 may be a remote-control device. Set-top box 316 may include one or more circuit boards. In some embodiments, the circuit boards may include processing circuitry, control circuitry, and storage (e.g., RAM, ROM, hard disk, removable disk, etc.). In some embodiments, circuit boards may include an input/output path. More specific implementations of user equipment devices are discussed below in connection with FIG. 4. Each one of user equipment device 300 and user equipment system 301 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (e.g., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

A user may send instructions to control circuitry 304 using user input interface 310. User input interface 310 may be any suitable user interface, such as a remote control, mouse, trackball, keypad, keyboard, touchscreen, touchpad, stylus input, joystick, voice recognition interface, or other user input interfaces. Display 312 may be provided as a stand-alone device or integrated with other elements of each one of user equipment device 300 and user equipment system 301. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images.

The guidance application may be implemented using any suitable architecture. For example, it may be a stand-alone application wholly implemented on each one of user equipment device 300 and user equipment system 301. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

Each one of user equipment device 300 and user equipment system 301 of FIG. 3 can be implemented in system 400 of FIG. 4 as means for consuming content 402, system controller 404, wireless user communications device 406, or any other type of user equipment suitable for accessing content, such as a non-portable gaming machine. For simplicity, these devices may be referred to herein collectively as user equipment or user equipment devices and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as means for consuming content 402, system controller 404, or a wireless user communications device 406. For example, means for consuming content 402 may, like some system controller 404, be Internet-enabled allowing for access to Internet content, while system controller 404 may, like some television equipment 402, include a tuner allowing for access to television programming. The media guidance application may have the same layout on various different types of user equipment or may be tailored to the display capabilities of the user equipment. For example, on system controller 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

The user equipment devices may be coupled to communications network 414. Namely, means for consuming content 402, system controller 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 402-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and data source to determine knowledge level 418 coupled to communications network 414 via communication paths 420 and 422, respectively. Paths 420 and 422 may include any of the communication paths described above in connection with paths 408, 410, and 412. Communications with the content source 416 and data source to determine knowledge level 418 may be exchanged over one or more communications paths but are shown as a single path in FIG. 4 to avoid overcomplicating the drawing. In addition, there may be more than one of each of content source 416 and data source to determine knowledge level 418, but only one of each is shown in FIG. 4 to avoid overcomplicating the drawing. (The different types of each of these sources are discussed below.) If desired, content source 416 and data source to determine knowledge level 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content curator 426 is coupled to communications network 414 via communication path 424 and coupled to content source 416 via communication path 440. Paths 424 and 440 may include any of the communication paths described above in connection with paths 408, 410, and 412. Content curator 426 may obtain or receive media content from content source 416 via communication path 440.

System controller 404 may access content format preferences 432 and a calendar to identify events and dates 434. System controller 404 may retrieve data content format preferences 432 and calendar information from calendar to identify events and dates 434 via communications paths 428 and 430, respectively. Paths 428 and 430 may include any of the communication paths described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YouTube, Netflix, and Hulu, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Content curator 426 may retrieve optimal formats for curating media content from the optimal format database 438. Communications with the content curator 426 and optimal format database 438 may be exchanged over one or more communications paths including communication paths 424 and 436 but are shown as a single path in FIG. 4 to avoid overcomplicating the drawing.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

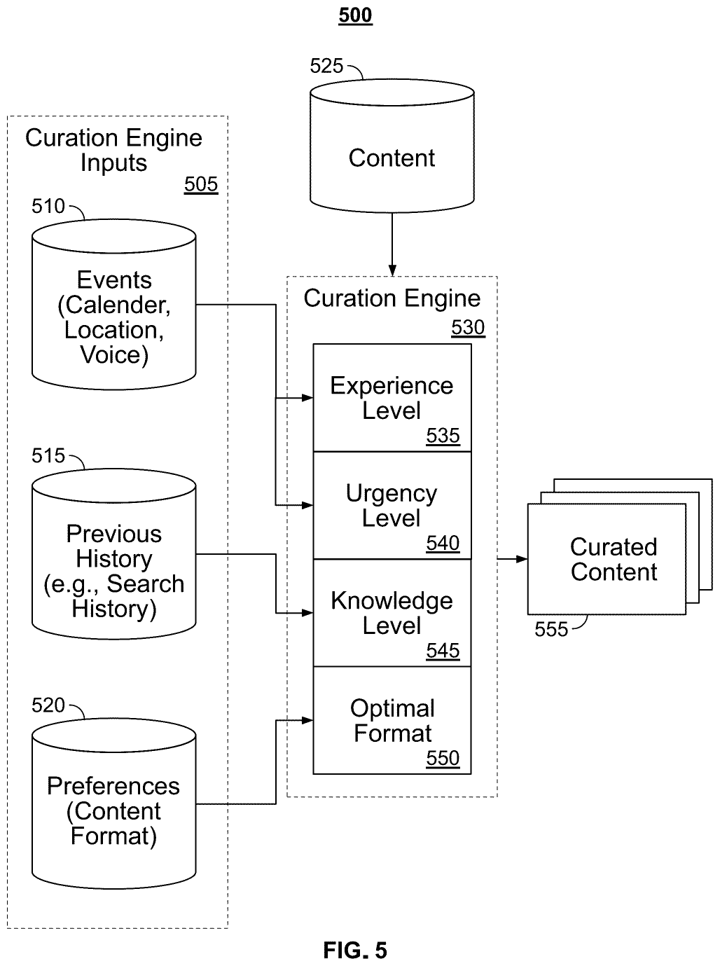

FIG. 5 is a diagram of information flow into a curation engine to create a curated content bundle. In process 500, the curation engine inputs 505 include events 510 and data associated with the events. Such data may include calendar information, such as calendar information received from a calendar to identify events and dates 434. The data additionally or alternatively includes location information about the event. Finally, the data may include voice inputs or other inputs from the user. The curation engine inputs 505 also include previous history 515, which may include the user's search history. Finally, the curation engine inputs 505 include preferences 520, such as content format preferences. The curation engine inputs 505 are input into the curation engine 530, along with content 525. Content 525 may be obtained from content source 416. The curation engine 530 may receive and analyze the curation engine inputs 505 in a number of ways. In some embodiments, curation engine 530 uses events 510 to determine experience level 535 and urgency level 540. The curation engine 530 uses previous history 515 to determine knowledge level 545 and uses preferences 520 to determine optimal format 550. Finally, the curation engine outputs curated content 555.

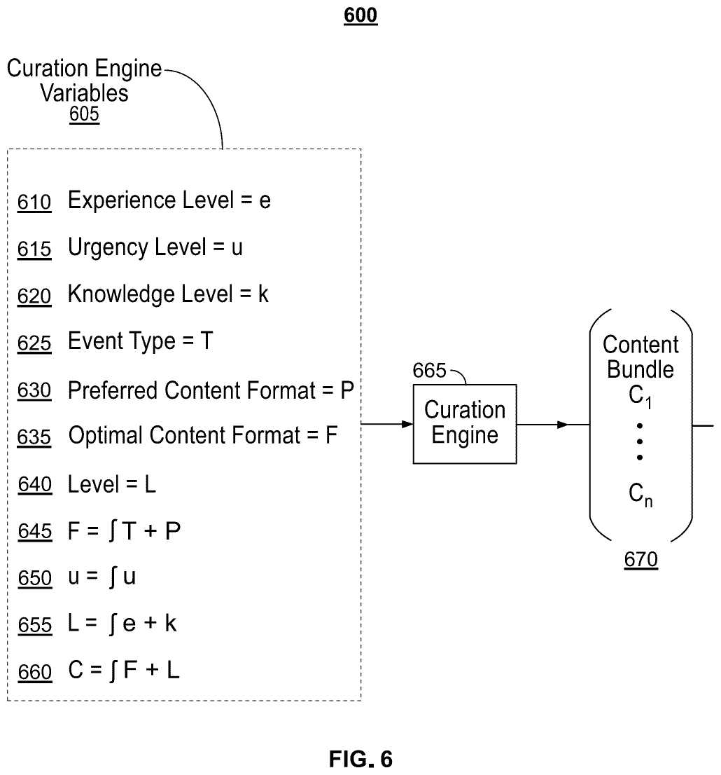

FIG. 6 depicts an illustrative formulaic engine for creating a content bundle. Curation engine variables 605 include experience level 610, urgency level 615, knowledge level 620, event type 625, preferred content format 630, optimal content format 635, and level 640, which may correspond to labels such as beginner, intermediate, advanced, etc. The curation engine 665 combines these variables to create content bundle 670. These variables may be combined in a number of formulas. In particular, optimal content format 635 is related to event type 625 and preferred content format 630 by the formula F=∫T+P, 645. Urgency level 615 is defined as u=∫u, 650. Level 640 relates to experience level 610 and knowledge level 620 by the formula L=∫e+k, 655. Finally, content bundle 670 relates to optimal content format 635 and level 640 by the formula C=∫F+L, 660. It should be noted that the process 600 may be embodied by control circuitry 304 or any of the system components shown in FIGS. 3-4.

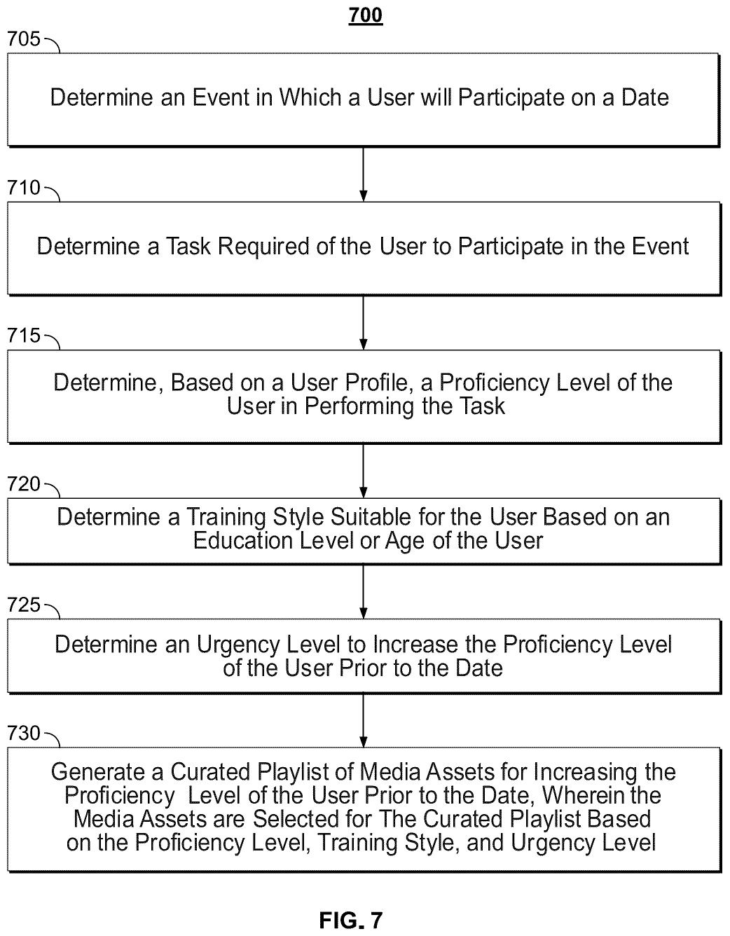

FIG. 7 depicts an embodiment of a process for generating a curated playlist of media assets for increasing a proficiency level of a user prior to a date of an event. It should be noted that each step of process 700 can be performed by control circuitry 304 (e.g., in a manner instructed to control circuitry 304 by the application) or any of the system components shown in FIGS. 3-4. Control circuitry 304 may be part of user equipment (e.g., a device that may have any or all of the functionality of means for consuming content 402, system controller 404, and/or wireless communications device 406), or of a remote server separated from the user equipment by way of communication network 414, or distributed over a combination of both.

At step 705, process 700 determines an event (e.g., event 215) in which a user will participate on a date (e.g., date 220). In order to determine the event (e.g., event 215), the application (e.g., via control circuitry 304) may receive a signal from a remote server indicating the event (e.g., event 215). For example, the application (e.g., via control circuitry 304) may receive a notification from a social media network application of a user indicating that the user has signed up to participate in an event. Control circuitry 304 may analyze the metadata relating to the event in order to determine the name of the event (e.g., event 215), the location of the event, and the date (e.g., date 220) of the event. Control circuitry 304 may then store the details of the event in memory (e.g., storage 308) and/or in cloud-based storage. Additionally or alternatively, control circuitry 304 may receive user input about an event (e.g., event 215) from a user input interface (e.g., user input interface 310), which may correspond to devices 210 and/or 300. The user input may include data such as the event (e.g., event 215) and the date (e.g., date 220). The user input interface (e.g., user input interface 310) may additionally prompt the user to enter information such as the knowledge level (e.g., knowledge level 225) and proficiency level (e.g., proficiency level 230), which will be later processed by control circuitry 304.

In some embodiments, control circuitry 304 determines the event (e.g., event 215) by searching through the user's calendar application for upcoming events. If control circuitry 304 finds an upcoming event, control circuitry 304 may retrieve metadata such as the name of the event (e.g., event 215), the location of the event, and the date (e.g., date 220) of the event. Control circuitry 304 may then store details of the event (e.g., event 215) in memory (e.g., storage 308) and/or in cloud-based storage.

Control circuitry 304 may utilize natural language processing in order to analyze the details of the event (e.g., event 215). Natural language processing involves breaking down language (e.g., spoken language, text data, or other language inputs) into shorter pieces and analyzing the relationships between these pieces using a variety of techniques. Natural language processing systems may use content categorization to create a summary, index a document, and detect duplications. Topic discovery allows a natural language processing system to extract meanings and themes from language. Contextual analysis allows a processor to capture structural information about a quantity of text or spoken language. Processors may conduct sentiment analysis to determine mood or subjective opinion within language. Additionally or alternatively, natural language processors may conduct speech-to-text conversion or text-to-speech conversion to translate between different forms of language.

Control circuitry 304 may parse the metadata related to the event (e.g., event 215), as retrieved from a social media application, user input interface (e.g., user input interface 310), or user calendar application, using natural language processing in order to determine to what the event relates. Control circuitry 304 may compare keywords in the metadata to a lexicon and may further apply grammar rules to determine a meaning of the event. Control circuitry 304 may further use natural language processing to determine if the event (e.g., event 215) indicates a need for preparation. For example, the details of the metadata may indicate that a user must possess a special skill set in order to participate in such an event. Control circuitry 304 may thus determine that the event (e.g., event 215) is a candidate for a curated playlist for increasing proficiency.

Additionally or alternatively, the details of the metadata may indicate a particular role of the user in the event. For example, a given event many have a plurality of roles that may be performed for the event and/or at the event. The metadata (e.g., text indicating the context of the event and/or the type of the event, function of the user at the event, and/or role of the user at the event) may be parsed by the system to determine these details. By doing so, the number of potential tasks needed to be searched may be limited to particular tasks associated with a given type, function, role, etc. Additionally or alternatively, the details of the metadata (and/or a predetermined role of the user) may indicate a particular proficiency level of the user required for the event. For example, if the metadata indicates that a user is attending an event in a particular role (e.g., as a spectator), the system may determine that the user needs a first proficiency level (e.g., a cursory or background knowledge of the subject matter of the event in order to understand the event). If the metadata indicates that the user is attending the event in a different role (e.g., as a performer), the system may determine that the user needs a second proficiency level (e.g., knowledge of how to, and an ability to, perform the subject matter of the event). In some embodiments, the determined knowledge, skills, etc., of a higher proficiency level include knowledge, skills, etc., of a lower proficiency level. Alternatively, the determined knowledge, skills, etc., of a higher proficiency level are different from the knowledge, skills, etc., of a lower proficiency level.

Control circuitry 304 may input data related to the event (e.g., event 215) into a database. The database may be stored in memory (e.g., storage 308) and/or in cloud-based storage. The database may possess a structure such that control circuitry 304 and/or the user can easily navigate between events to access corresponding data for each event.

At step 710, process 700 determines a task required of the user to participate in the event (e.g., event 215). In order to determine a task, control circuitry 304 may send a signal of the event (e.g., event 215) to a database (e.g., content source 416) comprising listings of events. By comparing the details (tags, metadata, identifiers, etc.) of the event (e.g., event 215) to the details of available events in the database (e.g., content source 416), process 700 may find a matching event. Additionally or alternatively, process 700 may compare the event (e.g., event 215) to a database (e.g., content source 416) comprising listings of tasks associated with events. In selecting tasks associated with the event (e.g., event 215), control circuitry 304 may analyze the metadata of both the event (e.g., event 215) and the tasks to match keywords, identifiers, or other relevant pieces of data.

In some embodiments, control circuitry 304 accesses data from additional databases in order to compile relevant information. For example, control circuitry 304 may access a database comprising user profiles for users who prepared for events in the past. Control circuitry 304 may locate user profiles tied to events similar to the event (e.g., event 215) to determine connected tasks. For instance, control circuitry 304 may analyze which tasks previous users searched for and which tasks previous users completed in preparing for such events. Control circuitry 304 may input this data from previous user profiles into a database comprising event and task pairings.

In some embodiments, control circuitry 304 may determine an importance rating for each task relative to an event. For example, control circuitry 304 may scan external databases to determine the frequency at which a given task and a given event are paired. By comparing the frequency of pairings of various tasks and events, control circuitry 304 may determine which tasks are most relevant and important to a given event. Control circuitry 304 may also determine a hierarchy of tasks by analyzing in which order tasks were performed. For example, control circuitry 304 may observe that a given number of tasks are always performed in a specific order when connected to a particular event. This may indicate that the particular order of tasks is related to an increase in proficiency or knowledge. Additionally or alternatively, control circuitry 304 may analyze dependencies between tasks. For example, if a first task is always performed before a second task is performed and the second task is never performed without the first task having been performed, control circuitry 304 may determine that the second task is dependent on the user having completed or mastered the first task. Control circuitry 304 may store metadata related to frequency, hierarchy, and dependency in a database along with the tasks and events.

In order to navigate the large quantity of tasks and events available, control circuitry 304 may develop a navigation technique for locating and extracting information from various databases. For example, control circuitry 304 may encounter a database structured as a knowledge graph. A knowledge graph may represent entities as nodes in a graph and may connect related entities by so-called edges. The edges may further be associated with weights to determine whether there is a strong or weak interrelation between the entities. In order to locate the desired data, control circuitry 304 may search for nodes using keywords related to an event (e.g., event 215). Once control circuitry 304 locates an event similar to the event (e.g., event 215), it may search along the edges for connected nodes that correspond to tasks. The distance, or number of edges, separating the event's node from a given task's node may indicate the importance or relevance of the task to the event. Control circuitry 304 may also incorporate the weighting of the edges in order to determine importance and relevancy of related tasks. Additionally or alternatively, control circuitry 304 may analyze the number and weighting of the edges connecting various tasks related to the same event. Control circuitry 304 may use this information to determine relationships between the tasks such as relative importance, hierarchy, and dependency. Control circuitry 304 may then input the metadata retrieved from the knowledge graph into a database.

In some embodiments, control circuitry 304 may create a list of tasks for a given event through the use of a search engine. The search engine may make an index using a web crawler to automatically browse the Internet and store information (e.g., words frequently used on the same page, within the same sentence, and/or within a particular proximity to the event word). Every time a web crawler identifies words related to a task and/or event, the web crawler adds the words to an index. For example, the word corresponding to the event may constitute a record in the index, with the index providing a list of the words corresponding to each task word.

Control circuitry 304 may sort the results in the index. For example, control circuitry 304 may incorporate and/or implement a sort algorithm, such as page rank, in which each instance of a word corresponding to a task that points to a word corresponding to an event increases the rank of the word. The word corresponds to the task for the word corresponding to the event webpage, indicating that it is more useful. Accordingly, control circuitry 304 may use the ranking to return the most popular tasks associated with a given event. In some embodiments, the order of the task may correspond to the importance rating discussed above.

In step 715, process 700 determines a proficiency level (e.g., proficiency level 240) of the user in performing the task. In order to determine the proficiency level (e.g., proficiency level 240), control circuitry 304 may access a user profile of the user in order to search for pieces of data tagged with identifiers related to the details of the event. Control circuitry 304 may access the user profile through applications stored on the system controller (e.g., system controller 404), wireless user communications device (e.g., wireless user communications device 406), or cloud-based storage, or through direct user input through a user input interface (e.g., user input interface 310). If, for example, the user is preparing for an audition for a musical, control circuitry 304 may search the user profile for data related to singing lessons, music groups, acting experience, dance training, and other related identifiers. Control circuitry 304 may then send data gathered from the user profile to the content source (e.g., content source 416). By comparing the data associated with the user to the data associated with the event (e.g., event 215), control circuitry 304 may determine a level of proficiency of the user in performing tasks required to participate in the event (e.g., event 215).

In some embodiments, control circuitry 304 prompts the user to input a level of proficiency that they believe to be most accurate (e.g., proficiency level 230). Control circuitry 304 may prompt the user for this information instead of analyzing the user profile for the user or may alternatively use the user input and the user profile together. For example, control circuitry 304 may determine, based on the user profile, that the user's proficiency for a given task is within a certain range. Control circuitry 304 may then prompt the user to select (e.g., via user input interface 310) which proficiency within the range best fits their abilities.

In some embodiments, control circuitry 304 accesses a database of user profiles that include proficiencies of users in completing various tasks. By analyzing a large quantity of profiles for users who have performed a given task in the past, control circuitry 304 may determine certain trends in the metadata. For example, control circuitry 304 may determine that users of a certain age, height, demographic, geographic location, or other characteristic possess an average proficiency for a given task. Additionally or alternatively, control circuitry 304 may determine that users of a certain characteristic possess increased or decreased proficiencies for the given task. Control circuitry 304 may compare this data to the user profile for a particular user. Control circuitry 304 may access the average proficiency level for users with the same characteristics as the user profile of the user and assign that proficiency level to the user. Additionally or alternatively, control circuitry 304 may determine if there are any characteristics in the user profile of the user that indicate increased or decreased proficiency for a given task.

In step 720, process 700 determines content format preferences (e.g., content format preferences 245) suitable for the user based on the knowledge level (e.g., knowledge level 225) and proficiency level (e.g., proficiency level 230) of the user. In one example, control circuitry 304 may access the user profile to extract the age of the user as well as the knowledge level (e.g., knowledge level 225) in fields relevant to the event (e.g., event 215). In another example, control circuitry 304 may require direct user input via user input interface (e.g., user input interface 310). Control circuitry 304 may search a database (e.g., content source 416) for data relating content formats to proficiency level and knowledge level. Control circuitry 304 may further search for average experience levels and educational backgrounds associated with different listings of content formats in order to determine which content format best matches the data in the user profile of the user. Based on comparing the data of the user to the data associated with listings of content formats, process 700 may determine a suitable content format for the user.

In some embodiments, control circuitry 304 retrieves a history from the user profile of a user that comprises previous events for which the user prepared. Control circuitry 304 may analyze the metadata of each event listing to extract past content formats the user utilized in preparing for events. Control circuitry 304 may further compare how quickly and effectively the user's proficiency level improved across different content formats. Control circuitry 304 may incorporate which content formats are most effective for which types of events. For example, control circuitry 304 may determine that a text-based content format improved the user's proficiency level most efficiently in the past for events similar to the event (e.g., event 215). In response, control circuitry may determine that these content format preferences (e.g., content format preferences 245) should be used to prepare the user for the event (e.g., event 215). In another example, control circuitry may determine that video-based content formats with particular endorsements were effective in the past and should be used again. Control circuitry 304 may analyze a variety of factors, such as language, motivation, intensity, frequency, and social involvement, to determine effectiveness. Control circuitry 304 may then pair the most effective content format preferences (e.g., content format preferences 245) for a particular type of event (e.g., event 215) in a database.

In some embodiments, control circuitry 304 accesses a database of user profiles that include content formats for users in preparing for various events in the past. By analyzing a large quantity of profiles for users who utilized given content formats in the past, control circuitry 304 may determine certain trends in the metadata. For example, control circuitry 304 may determine that users of a certain age, height, demographic, geographic location, or other characteristic improve better with specific content formats. Additionally or alternatively, control circuitry 304 may determine that users of a certain characteristic react more positively or negatively to certain content formats. Control circuitry 304 may compare this data to the user profile for a particular user. Control circuitry 304 may access the most commonly preferred content formats for users with the same characteristics as the user profile of the user and assign those content format preferences (e.g., content format preferences 245) to the user. Additionally or alternatively, control circuitry 304 may determine if there are any characteristics in the user profile of the user that indicate that a user may react negatively to a certain content format and may instead assign a different content format to the user.

In step 725, process 700 determines an urgency level (e.g., urgency 250) to increase the proficiency (e.g., proficiency level 240) of the user prior to the date (e.g., date 220). For example, control circuitry 304 may monitor applications on the user's wireless user communications device (e.g., wireless user communications device 406) in order to detect mentions of the event (e.g., event 215). Control circuitry 304 may do this monitoring via voice detection techniques wherein control circuitry 304 counts instances in which the user states the title of the event in conversation while in the proximity of the system controller (e.g., system controller 404). In another example, control circuitry 304 may analyze text data, exchanged between a wireless user communications device (e.g., wireless user communications device 406) and other devices, via messaging, social media, and/or other applications, for text that matches data identifying the event (e.g., event 215). In these examples, control circuitry 304 may count the number and frequency of references to the event (e.g., event 215) in order to calculate urgency level (e.g., urgency 250). Control circuitry 304 may store data relating to these references on local memory (e.g., storage 308) and/or in cloud-based storage in order to track changes in frequency. Control circuitry 304 may periodically update the urgency level (e.g., urgency 250) based on the frequency.

At step 730, process 700 generates a curated playlist of media assets (e.g., curated content bundle 135) for increasing the proficiency level (e.g., proficiency level 240) of the user prior to the date (e.g., date 220), wherein the media assets (e.g., media assets 255, 260, 265, and 270) are selected for the curated playlist (e.g., curated content bundle 135) based on the proficiency level (e.g., proficiency level 240), content format preferences (e.g., content format preferences 245), and urgency level (e.g., urgency 250). For example, control circuitry 304 may access a database (e.g., content source 416) comprising a listing of media assets, each of which comprises identifying information and data relating to proficiency level and content formats. Control circuitry 304 may filter the listing of media assets to include only media assets related to the task required for the event (e.g., event 215), based on the metadata of each media asset (i.e., tags, identifiers, etc.). Additionally or alternatively, control circuitry 304 may filter the listing again to include only media assets which, as indicated in the metadata of the media assets, require a proficiency level (e.g., proficiency level 240) equal to or above that of the user. Additionally or alternatively, control circuitry 304 may further filter the listing of media assets again to include a number of media assets that is appropriate for the urgency level (e.g., urgency 250) of the event (e.g., event 215).

In some embodiments, control circuitry 304 utilizes a feedback loop to update the curated playlist (e.g., curated content bundle 135) based on the progress of the user in increasing their proficiency level (e.g., proficiency level 240). For example, control circuitry 304 may conduct a proficiency test for the user after each task, video, or set of videos. The proficiency test may monitor changes in speed, skill, agility, weight, or another relevant factor. Control circuitry 304 may monitor these factors by retrieving biometric feedback from a user device. Additionally or alternatively, control circuitry 304 may prompt the user to input information regarding their progress. For example, the user may input the goals they have met and/or their comfort and success in completing a set of tasks. Based on the results of each proficiency test, control circuitry 304 may determine an updated proficiency level for the user.

In some embodiments, control circuitry 304 determines, based on the updated proficiency level, if the user is progressing at a similar rate as other users who prepared for similar events in the past. For example, control circuitry 304 may access a database of user profiles for users who have prepared for similar events in the past. Control circuitry 304 may determine an average progression rate throughout the preparation period across all these users. Additionally or alternatively, control circuitry 304 may extract the proficiency level of previous users who prepared for a similar task when those users were at the same stage of preparation. Thus, control circuitry 304 evaluates the progress of the user based on available data from previous users. Control circuitry 304 can use this evaluation to determine if the curated playlist (e.g., curated content bundle 135) is configured for the best preparation of the user.

In some embodiments, control circuitry 304 may determine that it must update the curated playlist (e.g., curated content bundle 135) based on the progress of the user. For example, if the user's updated proficiency level is far higher than the average proficiency level at a particular stage of preparation, control circuitry 304 may change the content format (e.g., content format preferences 245) to match the heightened progression rate of the user. Alternatively, if the user's updated proficiency level has not increased or if it is far lower than the average proficiency level at a particular stage of preparation, control circuitry 304 may adjust the initial proficiency level down or may change the content format (e.g., content format preferences 245) to a more effective style for the user.

In some embodiments, control circuitry 304 may use a content-recognition module or algorithm to determine an initial and/or updated proficiency level (e.g., proficiency level 240). The content-recognition module may use object recognition techniques such as edge detection or pattern recognition, including, but not limited to, self-learning systems (e.g., neural networks), optical character recognition, online character recognition (including, but not limited to, dynamic character recognition, real-time character recognition, intelligent character recognition), and/or any other suitable technique or method to determine the objects and/or characteristics in captured content (e.g., a video). For example, the control circuitry 304 may receive media assets in the form of a video. The video may include a series of frames. For each frame of the video and/or based on a series of frames, control circuitry 304 may use a content-recognition module or algorithm to determine the current proficiency of the user based on monitoring one or more characteristics and/or objects in the video. For example, control circuitry 304 may determine the speed at which a user completes a task (e.g., if speed at the task is relevant to the proficiency level of the user). The characteristic and/or object that is monitored for may be determined based on inputting the task into a database that lists objects and/or characteristics indicative of a proficiency level of the user for a given task. The outputted object and/or characteristic may then be monitored by control circuitry 304.

In some embodiments, the content-recognition module or algorithm may also include speech recognition techniques, including but not limited to Hidden Markov Models, dynamic time warping, and/or neural networks (as described above) to translate spoken words into text. The content-recognition module may also use other techniques for processing audio and/or visual data. For example, the control circuitry 304 may monitor the user (or other users) for comments indicative of the proficiency level of the user.

In addition, control circuitry 304 may use multiple types of optical character recognition and/or fuzzy logic, for example, when determining the context of a keyword(s) retrieved from data (e.g., media data, translated audio data, subtitle data, user-generated data, etc.) associated with the media asset (or when cross-referencing various types of data with databases indicating the different contexts of events, tasks in an event, etc., as described herein). For example, the particular data field may be a textual data field. Using fuzzy logic, the system may determine two fields and/or values to be identical even though the substance of the data field or value (e.g., two different spellings) is not identical. In some embodiments, the system may analyze particular data fields of a data structure or media asset frame for particular values or text. The data fields could be associated with characteristics, additional information, and/or any other data required for the function of the embodiments described herein. Furthermore, the data fields could contain values (e.g., the data fields could be expressed in binary or any other suitable code or programming language).

It should be noted that this embodiment can be combined with any other embodiment in this description and that process 700 is not limited to the devices or control components used to illustrate process 700 in this embodiment.

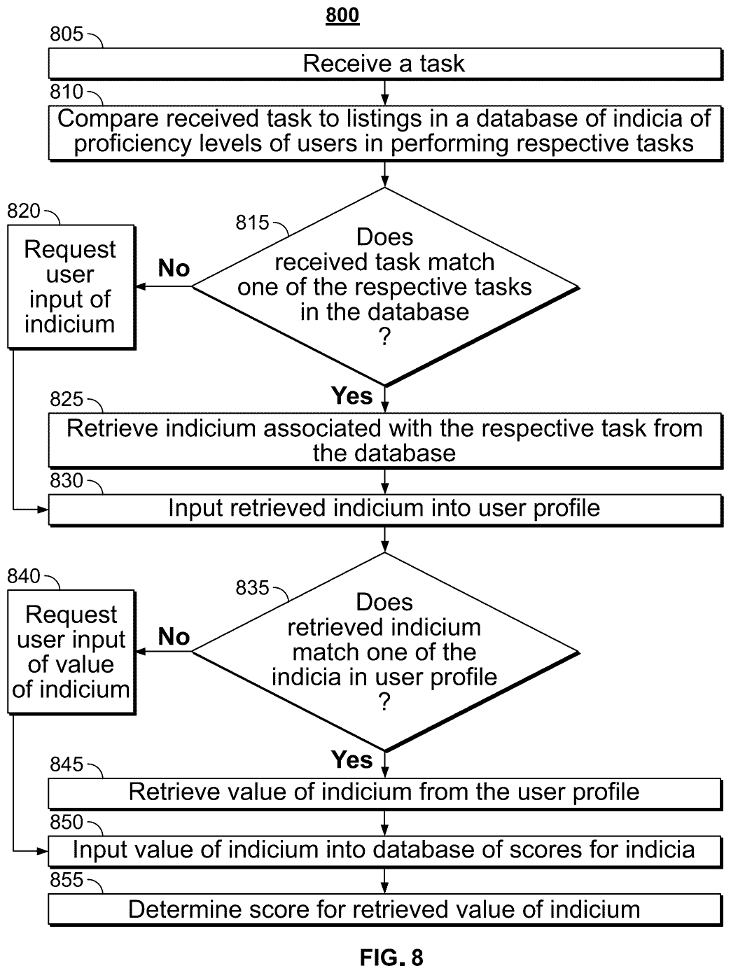

FIG. 8 is an embodiment of a process for determining a score for a retrieved value of an indicium. It should be noted that each step of process 800 can be performed by control circuitry 304 (e.g., in a manner instructed to control circuitry 304 by the application) or any of the system components shown in FIGS. 3-4. Control circuitry 304 may be part of user equipment (e.g., a device which may have any or all of the functionality of means for consuming content 402, system controller 404, and/or wireless communications device 406), or of a remote server separated from the user equipment by way of communication network 414, or distributed over a combination of both.

At step 805, process 800 receives a task. For example, control circuitry 304 may receive a signal from a remote server and/or the application which indicates a task required for the user to complete the event (e.g., event 215).

At step 810, process 800 compares the task to listings in a database (e.g., content source 416), which comprises indicia of proficiency levels of users in performing respective tasks. For example, control circuitry 304 may access a database of indicia of levels of proficiency in learning to play soccer and may compare these indicia to the received task, in which the user must learn various soccer skills and rules.

At step 815, process 800 determines whether the received task matches one of the respective tasks in the database (e.g., content source 416). Control circuitry 304 may make this determination by comparing identifying data (i.e. tags, titles, etc.) of the received task to identifying data of the respective tasks to search for a match. If control circuitry 304 determines that the received task does not match any of the respective tasks in the database (e.g., content source 416), then process 800 continues at step 820. If control circuitry 304 determines that the received task does match one of the respective task in the database (e.g., content source 416), then process 800 continues at step 825.

At step 820, process 800 requests user input of an indicium of a proficiency level 240 with respect to the received task. The user may enter an indicium of a proficiency level (e.g., proficiency level 240) via user input interface (e.g., user input interface 310). After the user inputs the requested information, process 800 continues at step 830.

At step 825, process 800 retrieves the indicium associated with the respective task from the database (e.g., content source 416). For example, control circuitry 304 may request, from the database, a signal comprising the indicium associated with the respective task matching the received task.

At step 830, process 800 inputs the retrieved indicium into the user profile for the user. In some examples, the retrieved indicium may be from the database (e.g., content source 416), and in other examples the retrieved indicium may be from the user input interface (e.g., user input interface 310).

At step 835, process 800 determines whether the retrieved indicium matches one of the indicia in the user profile of the user. For example, control circuitry 304 may compare tags and identifiers associated with each indicium in order to determine if there is a match. If control circuitry 304 determines that the retrieved indicium does not match any of the indicia in the user profile of the user, then process 800 continues at step 840. If control circuitry 304 determines that the retrieved indicium does match one of the indicia in the user profile of the user, then process 800 continues at step 845.

At step 840, process 800 requests user input of a value of the indicium of the proficiency level (e.g., proficiency level 240) with respect to the received task. The user may enter a value of the indicium of the proficiency level (e.g., proficiency level 240) via user input interface (e.g., user input interface 310). After the user inputs the requested indicium value, process 800 continues at step 850.

At step 845, process 800 retrieves the value of the indicium from the user profile of the user. For example, control circuitry 304 may retrieve a single value, a pairing of the value and the indicium, or a packet of information related to value, indicium, and proficiency level (e.g., proficiency level 240).

At step 850, process 800 inputs the value of the indicium into a database of scores for indicia. For example, control circuitry 304 may send a signal to a database such as a content source (e.g., content source 416) comprising scores of indicia, wherein the signal comprises the value of the indicium from the user profile or the value of the indicium received via direct user input at step 840.

At step 855, process 800 determines a score for the retrieved value of the indicium. For example, control circuitry 304 may compare the value of the indicium with the scores for the indicia to determine a matching score.

It should be noted that this embodiment can be combined with any other embodiment in this description and that process 800 is not limited to the devices or control components used to illustrate process 800 in this embodiment.

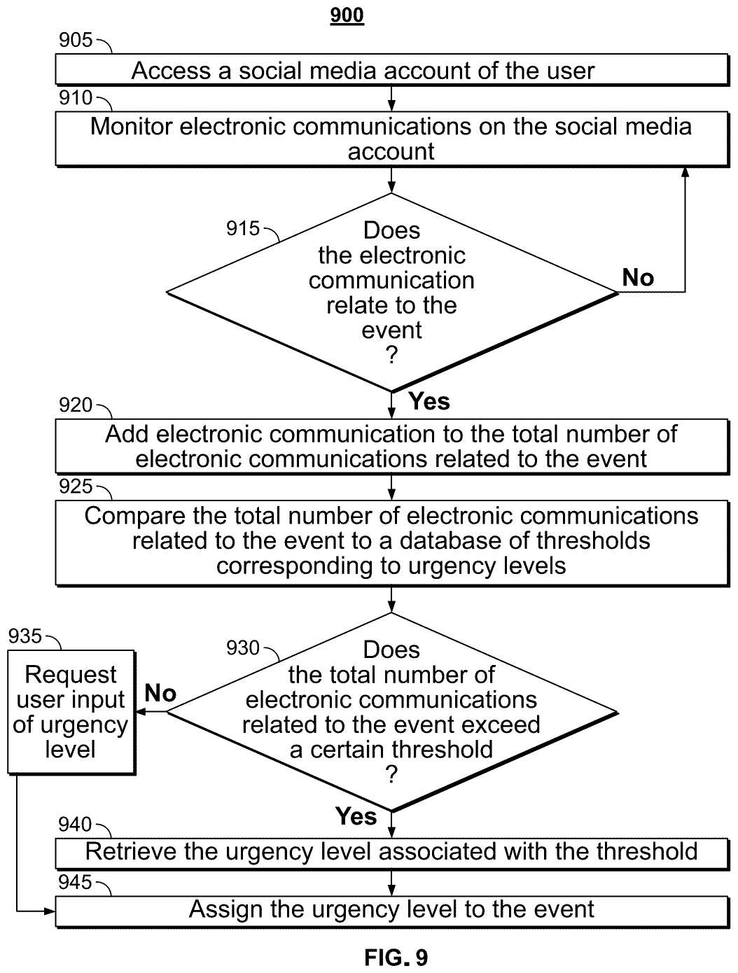

FIG. 9 is an embodiment of a process for assigning an urgency level to the event (e.g., event 215). It should be noted that each step of process 900 can be performed by control circuitry 304 (e.g., in a manner instructed to control circuitry 304 by the application) or any of the system components shown in FIGS. 3-4. Control circuitry 304 may be part of user equipment (e.g., a device which may have any or all of the functionality of means for consuming content 402, system controller 404, and/or wireless communications device 406), or of a remote server separated from the user equipment by way of communication network 414, or distributed over a combination of both.

At step 905, process 900 accesses a social media account of the user. For example, control circuitry 304 may access social media applications of the user on the wireless user communications device (e.g., wireless user communications device 406).

At step 910, process 900 monitors electronic communications on the social media account. For example, control circuitry 304 may analyze text data exchanged between the user and other individuals via social media applications stored on a wireless user communications device (e.g., wireless user communications device 406) or on the system controller (e.g., system controller 404). In another example, control circuitry 304 may analyze the contents of postings made by the user on the social media account.

At step 915, process 900 determines whether a particular electronic communication relates to the event (e.g., event 215). Control circuitry 304 may make this determination based on comparing tags and identifiers associated with the particular electronic communication to tags and identifiers associated with the event (e.g., event 215). If control circuitry 304 determines that the electronic communication does not relate to the event (e.g., event 215), process 900 returns to step 910. If, instead, control circuitry 304 determines that the electronic communication does relate to the event (e.g., event 215), then process 900 proceeds to step 920.

At step 920, process 900 adds the electronic communication to the total number of electronic communications related to the event (e.g., event 215). For example, control circuitry 304 may store an updated count of electronic communications related to the event (e.g., event 215) in local memory (e.g., storage 308) on the system controller (e.g., system controller 404) and/or in cloud-based storage. When control circuitry 304 detects a new electronic communication related to the event (e.g., event 215), control circuitry 304 updates the number in local storage (e.g., storage 308) and/or in cloud-based storage.

At step 925, process 900 compares the total number of electronic communications related to the event 215 to a database (e.g., content source 416) of thresholds corresponding to urgency levels 250.

At step 930, process 900 determines whether the total number of electronic communications related to the event (e.g., event 215) exceeds a certain threshold. For example, control circuitry 304 may send a signal, to the database (e.g., content source 416), containing information about the total number of electronic communications related to the event (e.g., event 215). The signal may also comprise a request for a point-by-point comparison between the total number of electronic communications related to the event (e.g., event 215) and the listing of thresholds. If control circuitry 304 determines that the total number of electronic communications related to the event (e.g., event 215) does not exceed any thresholds, then process 900 continues at step 935. If, instead, control circuitry 304 determines that the total number of electronic communications related to the event (e.g., event 215) does exceed a certain threshold, then process 900 continues at step 940.

At step 935, process 900 requests user input of the urgency level of the event (e.g., event 215). For example, the user may input the urgency level (e.g., urgency level 750) of the event (e.g., event 215) via user input interface (e.g., user input interface 310). Upon receiving user input of the urgency level, process 900 continues at step 945.

At step 940, process 900 retrieves the urgency level (e.g., urgency 250) associated with the threshold determined in step 930. For example, control circuitry 304 may send a request, to the database of thresholds, for the highest exceeded threshold in step 930 and the urgency level associated with the highest exceeded threshold.

At step 945, process 900 assigns the urgency level (e.g., urgency 250) to the event (e.g., event 215). The urgency level (e.g., urgency 250) may be the urgency level received via user input at step 935 or the urgency level retrieved from the database of thresholds at step 940. For example, control circuitry 304 may add the urgency level (e.g., urgency 250) to the metadata describing the event (e.g., event 215) in local storage (e.g., storage 308) and/or in cloud-based storage.

It should be noted that this embodiment can be combined with any other embodiment in this description and that process 900 is not limited to the devices or control components used to illustrate process 900 in this embodiment.

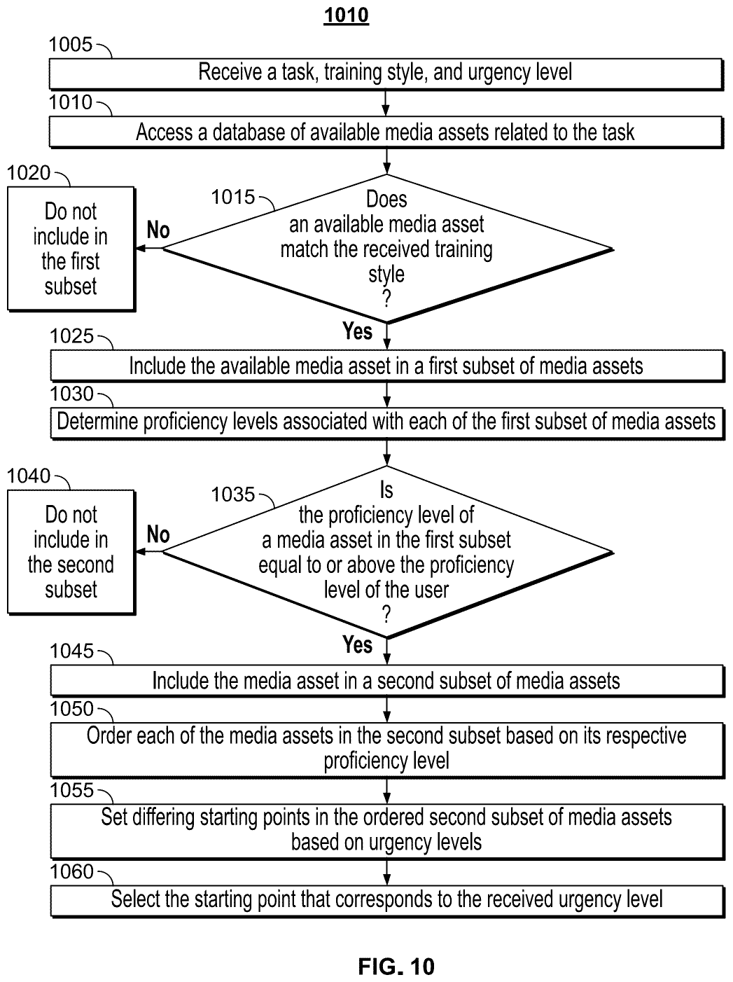

FIG. 10 is an embodiment of a process for setting a starting point, within the curated playlist of media assets, that corresponds to the urgency level received in process 900. It should be noted that each step of process 1000 can be performed by control circuitry 304 (e.g., in a manner instructed to control circuitry 304 by the application) or any of the system components shown in FIGS. 3-4. Control circuitry 304 may be part of user equipment (e.g., a device which may have any or all of the functionality of means for consuming content 402, system controller 404, and/or wireless communications device 406), or of a remote server separated from the user equipment by way of communication network 414, or distributed over a combination of both.

At step 1005, process 1000 receives a task, content format preferences (e.g., content format preferences 245), and urgency level (e.g., urgency 250). For example, control circuitry 304 may receive the task, content format preferences (e.g., content format preferences 245), and urgency level (e.g., urgency 250) from local storage (e.g., storage 308), an external memory source separated from the control circuitry 304 by way of a communications network (e.g., communications network 414), cloud-based storage, and/or another source.

At step 1010, process 1000 accesses a database (e.g., content source 416) of available media assets related to the task. For example, control circuitry 304 may send a signal indicating the task to a general database in order to locate a specific database comprising only media assets related to the task.

At step 1015, process 1000 determines whether an available media asset matches the received content format preferences (e.g., content format preferences 245). For example, control circuitry 304 may send the content format preferences (e.g., content format preferences 245) to the database and perform a comparison between content format preferences (e.g., content format preferences 245) and each content format associated with each available media asset. If control circuitry 304 determines that the available media asset does not match the received content format preferences (e.g., content format preferences 245), then process 1000 continues with step 1020. If control circuitry 304 determines that the available media asset does match the received content format preferences (e.g., content format preferences 245), then process 1000 continues with step 1025.

At step 1020, process 1000 does not include the specific media asset in the first subset of media assets. Process 1000 continues to perform step 1015 until control circuitry 304 finds an available media asset which matches the received content format preferences (e.g., content format preferences 245).

At step 1025, process 1000 includes the available media asset in the first subset of media assets. For example, control circuitry 304 may store data identifying the available media asset in local storage (e.g., storage 308) and/or in cloud-based storage. Control circuitry 304 may add each available media asset that matches the retrieved content format preferences (e.g., content format preferences 245) to the same storage location.

At step 1030, process 1000 determines proficiency levels associated with each media asset of the first subset of media assets. For example, control circuitry 304 may retrieve the proficiency levels from the metadata describing each media asset in the first subset of media assets. In another example, control circuitry 304 may retrieve the proficiency levels from additional data stored in the database (e.g., content source 416).

At step 1035, process 1000 determines if the proficiency level of a media asset in the first subset of media assets is equal to or above the proficiency level (e.g., proficiency level 240) of the user. For example, control circuitry 304 may retrieve the proficiency level 240 from the user profile of the user. Additionally or alternatively, control circuitry 304 may transmit the proficiency level (e.g., proficiency level 240) of the user to the storage location of the first subset of media assets in order to conduct a comparison of values. If control circuitry 304 determines that the proficiency level of the media asset is not equal to or above the proficiency level (e.g., proficiency level 240) of the user, then process 1000 continues with step 1040. If instead control circuitry 304 determines that the proficiency level of the media asset is equal to or above the proficiency level (e.g., proficiency level 240) of the user, then process 1000 continues with step 1045.

At step 1040, process 1000 does not include the media asset in the second subset of media assets. Process 1000 continues to perform step 1035 until control circuitry 304 finds an available media asset which comprises a proficiency level equal to or above the proficiency level (e.g., proficiency level 240) of the user.

At step 1045, process 1000 includes the media asset in a second subset of media assets. For example, control circuitry 304 may store data identifying the media asset in local storage (e.g., storage 308) and/or in cloud-based storage. Control circuitry 304 may add each media asset which has a corresponding proficiency level equal to or above the proficiency level (e.g., proficiency level 240) of the user to the same storage location.

At step 1050, process 1000 orders each of the media assets in the second subset of media assets based on each media asset's respective proficiency level. For example, control circuitry 304 may create a ranking, in decreasing order, of each proficiency level. Control circuitry 304 may then order the corresponding media assets by matching each media asset to its proficiency level.

At step 1055, process 1000 sets different starting points in the ordered second subset of media assets based on urgency level (e.g., urgency 250). For example, control circuitry 304 may select evenly spaced starting points between the lowest ranked media asset and the highest ranked media asset. Additionally or alternatively, control circuitry 304 may select a starting point corresponding to the proficiency level of every media asset in the second subset of media assets.

At step 1060, process 1000 selects the starting point that corresponds to the received urgency level (e.g., urgency 250). For example, if the event (e.g., event 215) has a low urgency level (e.g., urgency 250), control circuitry 304 may select a starting point in the second subset of media assets that has a low value. Alternatively, if the event (e.g., event 215) has a high urgency level (e.g., urgency 250), control circuitry 304 may select a starting point in the second subset of media assets that has a higher value.

It should be noted that this embodiment can be combined with any other embodiment in this description and that process 1000 is not limited to the devices or control components used to illustrate process 1000 in this embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A method comprising:
identifying an upcoming event;
determining an event proficiency level for completing the upcoming event;
determining a user proficiency level associated with a user profile;
determining one or more tasks for preparation for the upcoming event based on:
identifying one or more event keywords associated with the upcoming event;
performing a search based on the one or more event keywords;
based on results from the search, determining related words based on at least one of: a frequency with which the related words appear within a search results page, whether the related words are used in a same sentence with the one or more event keywords, or a proximity of the related words with the one or more event keywords in the search results;
generating an index of the related words;
identifying a corresponding task to each of the indexed related words;
for each indexed related word, determining a number of instances where the indexed related word points to an event keyword;
rating the corresponding task based on the number of instances; and
selecting one or more tasks based on at least one of a rating of a corresponding task, the event proficiency level, or the user proficiency level;
searching for one or more content items corresponding to the selected one or more tasks; and
generating a curated playlist comprising the one or more content items corresponding to selected one or more tasks.

2. The method of claim 1, wherein the event keyword describes the upcoming event.

3. The method of claim 1, wherein the user proficiency level is determined based on at least one of user characteristics associated with the user profile, proficiency levels associated with a plurality of user profiles sharing at least one user characteristic with the user profile, or proficiency levels associated with a plurality of user profiles associated with completion of the selected one or more tasks.

4. The method of claim 1, wherein selecting the one or more tasks is further based on an urgency level associated with the upcoming event.

5. The method of claim 4, wherein the urgency level is based on at least one of: a closeness between a current date and a date of the upcoming event, a frequency of comments associated with the user profile relating to the upcoming event, or a number of locations wherein communications associated with the user profile were detected relating to the upcoming event.

6. The method of claim 1, wherein the searching for the one or more content items corresponding to the selected task is further based on a content format of the content item, the content format comprising one of video content, audio content, or text content.

7. The method of claim 6, wherein the content format is determined based on at least one of: user characteristics associated with the user profile, the user proficiency level, a knowledge level associated with the user profile, a preferred learning style associated with the user profile, a likelihood of the content format to improve the user proficiency level, a frequency of use of the content format associated with the user profile, or an event type of the upcoming event.

8. The method of claim 1, further comprising:
determining an order of the one or more content items in the curated playlist, the order based on at least one of the user proficiency level, an urgency level associated with the upcoming event, tasks that depend on other tasks, or an order in which tasks should be performed; and
arranging the one or more content items in the curated playlist based on the determined order.

9. The method of claim 1, wherein the selecting the one or more tasks is further based on a frequency at which the one or more tasks is paired with the upcoming event.

10. The method of claim 1, wherein the selecting the one or more tasks is further based on:
searching for nodes of a weighted knowledge graph based on the one or more event keywords;
identifying a node corresponding to an event similar to the upcoming event based on the one or more event keywords, the similar event sharing a certain number of characteristics with the upcoming event; and
searching along edges of the node corresponding to the similar event to determine nodes corresponding to tasks for the similar event.

11. A system comprising:
control circuitry configured to:
identify an upcoming event;
determine an event proficiency level for completing the upcoming event;
determine a user proficiency level associated with a user profile;
determine one or more tasks for preparation for the upcoming event based on:
identifying one or more event keywords associated with the upcoming event;
performing a search based on the one or more event keywords;
based on results from the search, determining related words based on at least one of: a frequency with which the related words appear within a search results page, whether the related words are used in a same sentence with the one or more event keywords, or a proximity of the related words with the one or more event keywords in the search results;
generating an index of the related words;
identifying a corresponding task to each of the indexed related words;
for each indexed related word, determining a number of instances where the indexed related word points to an event keyword;
rating the corresponding task based on the number of instances; and
selecting one or more tasks based on at least one of a rating of a corresponding task, the event proficiency level, or the user proficiency level;
search for one or more content items corresponding to the selected one or more tasks; and
generate a curated playlist comprising the one or more content items corresponding to selected one or more tasks.

12. The system of claim 11, wherein the event keyword describes the upcoming event.

13. The system of claim 11, wherein the user proficiency level is determined based on at least one of user characteristics associated with the user profile, proficiency levels associated with a plurality of user profiles sharing at least one user characteristic with the user profile, or proficiency levels associated with a plurality of user profiles associated with completion of the selected one or more tasks.

14. The system of claim 11, wherein selecting the one or more tasks is further based on an urgency level associated with the upcoming event.

15. The system of claim 14, wherein the urgency level is based on at least one of: a closeness between a current date and a date of the upcoming event, a frequency of comments associated with the user profile relating to the upcoming event, or a number of locations wherein communications associated with the user profile were detected relating to the upcoming event.

16. The system of claim 11, wherein the searching for the one or more content items corresponding to the selected task is further based on a content format of the content item, the content format comprising one of video content, audio content, or text content.

17. The system of claim 16, wherein the content format is determined based on at least one of: user characteristics associated with the user profile, the user proficiency level, a knowledge level associated with the user profile, a preferred learning style associated with the user profile, a likelihood of the content format to improve the user proficiency level, a frequency of use of the content format associated with the user profile, or an event type of the upcoming event.

18. The system of claim 11, wherein the control circuitry is further configured to:
determine an order of the one or more content items in the curated playlist, the order based on at least one of the user proficiency level, an urgency level associated with the upcoming event, tasks that depend on other tasks, or an order in which tasks should be performed; and
arrange the one or more content items in the curated playlist based on the determined order.

19. The system of claim 11, wherein the selecting the one or more tasks is further based on a frequency at which the one or more tasks is paired with the upcoming event.

20. The system of claim 11, wherein the selecting the one or more tasks is further based on:
searching for nodes of a weighted knowledge graph based on the one or more event keywords;
identifying a node corresponding to an event similar to the upcoming event based on the one or more event keywords, the similar event sharing a certain number of characteristics with the upcoming event; and
searching along edges of the node corresponding to the similar event to determine nodes corresponding to tasks for the similar event.
